(19) United States
(12) Patent Application Publication
(10) Pub. No.: US 2022/0357044 A1
(43) Pub. Date: Nov. 10, 2022

(54) Stepless Temperature Control Method and System for Air Fryer

(71) Applicant: Shenzhen Hesung Innovation Technology Co., Ltd., Shenzhen (CN)

(72) Inventors: AiMin HE, Shenzhen (CN); XiangHe ZHANG, Shenzhen (CN)

(21) Appl. No.: 17/546,048

(22) Filed: Dec. 9, 2021

(30) Foreign Application Priority Data
May 7, 2021 (CN) 202110496395.9

(51) Int. Cl. F24C 7/08; A47J 37/06; A47J 36/32; F24C 15/32; G05D 23/19

(52) U.S. Cl. CPC F24C 7/087; A47J 37/0641; A47J 36/32; F24C 15/325; G05D 23/1917; A47J 2202/00

(57) ABSTRACT

A stepless temperature control method for an air fryer includes the steps of detecting and analyzing an air temperature in an air frying chamber of the air fryer in a real-time manner to obtain a temperature change in the air frying chamber, modulating a parameter of a stepless control signal according to a preset target temperature and the temperature change, and, in response to the modulated stepless control signal, adjusting a heating power of the air heater of the air fryer in a stepless manner, so as to maintain the air temperature in the air frying chamber between an upper limit and a lower limit of the preset target temperature.

### CROSS REFERENCE OF RELATED APPLICATION

This is a non-provisional application that claims the benefit of priority under 35 U.S.C. § 119 to a Chinese application, application number 202110496382.1, filed May 7, 2021, which is incorporated herewith by reference in its entirety.

### BACKGROUND OF THE PRESENT INVENTION

### Field of Invention

The present invention relates to air fryer, and more particularly to a stepless temperature control method and system for air fryer.

### Description of Related Arts

An air fryer is a kitchen appliance that cooks food, such as French fries, vegetables or meat, by circulating hot air instead of frying the food by boiling oils in a cooking pan. Through the circulating hot air in a food basket of the air fryer, moisture on the food surface will be removed to brown the food so as to achieve the conventional frying effect. Since the air fry is able to not only reduce the amount of fat in the food but also keep the frying qualities of the food, such as the appearance and taste of the fried food. Therefore, the air fryers are so popular and have great commercial values.

The existing air fryer generally comprises a housing, an electric heater disposed in the housing, a fan disposed in the housing, a frying basket detachably received in the housing and a controller that controls operations of the electric heater and the fan. When the food is placed in the frying basket and the frying basket is placed in the housing, a preset air temperature is set via the controller, such that the air in the housing will be heated by the electric heater and will be blown into the frying basket by the fan for air-frying the food in the frying basket. It is worth mentioning that the air temperature in housing for air-frying the food is maintained within a predetermined temperature range. For example, when the air temperature in the housing is detected greater than the preset temperature, the controller will power off the electric heater, i.e. no electrical power is consumed by the electric heater, the air temperature in the housing will be rapidly dropped. When air temperature in the housing is detected lower than the preset temperature, the controller will power on the electric heater, i.e. full electrical power is consumed by the electric heater, the air temperature in the housing will be rapidly increased.

However, since the above control method and the electric heater have limited features, the existing air frying will provide unstable air temperature control. Furthermore, if the rated power of the electric heater is higher, the thermal inertia of the electric heater is also larger. In other words, when the air in the housing is heated to the preset temperature, the electric heater will be powered off by the controller. Even though the controller is configured to power off the electric heater, the air temperature in the housing will continuously be increased under the action of thermal inertia. As a result, the air temperature in the housing will be significantly higher than the preset temperature. On the other hand, if the rated power of the electric heater is low, the heating speed of the electric heater is too slow. Particularly, after the electric heater is powered off to stop generating heat for a period of time, the electric heater will be cooled down due to no electrical power consumption. Meanwhile, the fan will be continuously operated to blow the air in the housing. As a result, the air temperature in the housing will be rapidly dropped. In other words, during the operation of the existing air fryer, the air temperature in the housing will fluctuate in a relatively large range, such that the vast air temperature fluctuation in the housing will affect the air-frying process to cook the food, such as the appearance and the taste of the food.

### SUMMARY OF THE PRESENT INVENTION

The invention is advantageous in that it provides a stepless temperature control method and system for air fryer, which can minimize the air temperature fluctuation range in the air fryer so as to improve the air frying ability of the air fryer.

Another advantage of the invention is to provide a stepless temperature control method and system for air fryer, which can control the heating power of the air heater of the air fryer via the pulse wave to accurately control the air temperature in the air fryer.

Another advantage of the invention is to provide a stepless temperature control method and system for air fryer, which can control the air heater being frequently switched between a high power working state and a low power working state via the high electric level and low electric level of the pulse wave, so as to accurately control the heating power of the air heater.

Another advantage of the invention is to provide a stepless temperature control method and system for air fryer, which can continuously adjust the heating power of the air heater by modulating the duty ratio and/or phase of the pulse wave, so as to adjust the air temperature in the air fryer in a stepless manner.

Another advantage of the invention is to provide a stepless temperature control method and system for air fryer, which can adjust the heating power of the air heating device by adjusting the effective working voltage or effective working current of the electric heater, so as to achieve the requirements of the stepless temperature control.

Another advantage of the invention is to provide a stepless temperature control method and system for air fryer, which can adjust the heating power of the air heater by changing the flow rate of the hot fluid in the fluid heat exchanger, so as to enhance the stepless temperature control.

Another advantage of the invention is to provide a stepless temperature control method and system for air fryer, wherein the air fryer is configured to provide a dry and low temperature environment for the motor of the fan to prolong the service life of the fan.

Another advantage of the invention is to provide a stepless temperature control method and system for air fryer, wherein greases and dirt can be easily cleaned and removed from the air fryer to ensure the safety and sanitation of the air fryer.

Another advantage of the invention is to provide a stepless temperature control method and system for air fryer, wherein no complicated structure or algorithms is used in the present invention in order to achieve the above mentioned objects. Therefore, the present invention successfully provides an economic and efficient solution not only for providing a simple control method and stepless speed control method for controlling the operation of the air fryer but also enhancing the practical use and reliability of the air fryer.

According to the present invention, the foregoing and other objects and advantages are attained by a stepless temperature control method for an air fryer having an air frying chamber, comprising the following steps.

S100: Detect and analyze an air temperature in the air frying chamber of the air fryer in a real-time manner to obtain a temperature change in the air frying chamber.

S200: Modulate a parameter of a stepless control signal according to a preset target temperature and the temperature change.

S300: In response to the modulated stepless control signal, adjust a heating power of the air heater of the air fryer in a stepless manner, so as to adjust the air temperature in the air frying chamber according to the preset target temperature.

In one embodiment, the stepless control signal is a pulse wave, wherein the preset target temperature is between an upper limit and a lower limit, the parameter of the stepless control signal includes the duty ratio and/or phase of the pulse wave.

In one embodiment, the step S300 of the stepless temperature control method further comprises the following steps.

In response to the high electric level of the pulse wave, controllably adjust the air heater in a high power working state for generating more amount of heat.

In response to the low electric level of the pulse wave, controllably adjust the air heater in a low power working state for generating less amount of heat.

In one embodiment, the step S200 of the stepless temperature control method further comprises the following steps.

In response to the current air temperature rising to a first temperature threshold between the upper limit and the lower limit of the preset target temperature, reduce the duty ratio of the pulse wave, such that the heating power of the air heater of the air fryer is reduced in a stepless manner.

In response to the current air temperature dropping to a second temperature threshold between the upper limit and the lower limit of the preset target temperature, increase the duty ratio of the pulse wave, such that the heating power of the air heater of the air fryer is increased in a stepless manner.

In one embodiment, the step S200 of the stepless temperature control method further comprises the following steps.

In response to the current air temperature rising to a first temperature threshold between the upper limit and the lower limit of the preset target temperature, backwardly adjust the phase of the pulse wave, such that the heating power of the air heater of the air fryer is adjustably reduced in a stepless manner.

In response to the current air temperature dropping to a second temperature threshold between the upper limit and the lower limit of the preset target temperature, forwardly adjust the phase of the pulse wave, such that the heating power of the air heater of the air fryer is adjustably increased in a stepless manner.

In one embodiment, in the step S300: the air heater comprises an electric heater which comprises a power supply circuit, an electric heating element and a switch control, wherein the electric heating element and the switch control are connected to the power supply circuit in series, wherein in response to the high electric level of the pulse wave, instantly switch on the power supply circuit via the switch control to adjust a current working voltage of the electric heating element equal to a real-time voltage applied to the electric heating element through the power supply circuit, such that the electric heater is in the high power working state; and in response to the low electric level of the pulse wave, instantly switch off the power supply circuit via the switch control to adjust the current working voltage of the electric heating element to zero, such that the electric heater is in the low power working state.

In one embodiment, the switch control is a solid state relay.

In one embodiment, in the step S300, the air heater comprises an electric heater which comprises a power supply circuit, an electric heating element and an adjustable resistor, wherein the electric heating element and the adjustable resistor are connected to the power supply circuit in series, wherein in response to the high electric level of the pulse wave, reduce the resistance value of the adjustable resistor to increase the current working voltage of the electric heating element, such that the electric heater is in the high power working state; and in response to the low electric level of the pulse wave, increase the resistance value of the adjustable resistor to reduce the current working voltage of the electric heating element, such that the electric heater is in the low power working state.

In one embodiment, in the step S300, the air heater comprises an electric heater which comprises a power supply circuit, an electric heating element and an adjustable resistor, wherein the electric heating element and the adjustable resistor are connected to the power supply circuit in parallel, wherein in response to the high electric level of the pulse wave, increase the resistance value of the adjustable resistor to increase the current working voltage of the electric heating element, such that the electric heater is in the high power working state; and in response to the low electric level of the pulse wave, reduce the resistance value of the adjustable resistor to reduce the current working voltage of the electric heating element, such that the electric heater is in the low power working state.

In one embodiment, in the step S300, the air heater comprises a fluid heat exchanger which comprises a heat supply pipeline, a fluid heat exchange element and a flow control device, wherein the fluid heat exchange element and the flow control device are connected to the heat supply pipeline, wherein in response to the high electric level of the pulse wave, increase the flow rate of the thermal fluid delivered to the fluid heat exchange element via the heat supply pipe through the flow control device, such that the fluid heat exchanger is in the high power working state; and in response to the low electric level of the pulse wave, reduce the flow rate of the thermal fluid delivered to the fluid heat exchange element via the heat supply pipe through the flow control device, such that the fluid heat exchanger is in the low power working state.

In accordance with another aspect of the invention, the present invention comprises a stepless temperature control system for an air fryer which has an air frying chamber for receiving a food therein and comprises an air circulation device and an air heater, comprising:

a temperature analysis module configured to detect and analyze an air temperature in the air frying chamber in real time to obtain an air temperature change of in the air frying chamber;

a signal modulation module configured to modulate a parameter of a stepless control signal according to a preset target temperature and the air temperature change; and

a power adjustment module configured to adjust a heating power of the air heater of the air fryer in a stepless manner in response to the modulated stepless control signal, so as to maintain the air temperature in the air frying chamber between an upper limit and a lower limit of the preset target temperature.

In one embodiment, the stepless control signal is a pulse wave, wherein the parameter of the stepless control signal includes the duty ratio and/or phase of the pulse wave.

In one embodiment, the power adjustment module is further configured to: in response to the high electric level of the pulse wave, controllably adjust the air heater in a high power working state for generating more amount of heat; and in response to the low electric level of the pulse wave, controllably adjust the air heater in a low power working state for generating less amount of heat.

In one embodiment, the signal modulation module comprises a duty ratio adjustment module configured to: in response to the current air temperature rising to a first temperature threshold between the upper limit and the lower limit of the preset target temperature, reduce the duty ratio of the pulse wave, such that the heating power of the air heater of the air fryer is reduced in a stepless manner; and in response to the current air temperature dropping to a second temperature threshold between the upper limit and the lower limit of the preset target temperature, increase the duty ratio of the pulse wave, such that the heating power of the air heater of the air fryer is increased in a stepless manner.

In one embodiment, the signal modulation module comprises a phase adjustment module configured to: in response to the current air temperature rising to a first temperature threshold between the upper limit and the lower limit of the preset target temperature, backwardly adjust the phase of the pulse wave, such that the heating power of the air heater of the air fryer is adjustably reduced in a stepless manner; and in response to the current air temperature dropping to a second temperature threshold between the upper limit and the lower limit of the preset target temperature, forwardly adjust the phase of the pulse wave, such that the heating power of the air heater of the air fryer is adjustably increased in a stepless manner.

In one embodiment, the air heater comprises an electric heater which comprises a power supply circuit, an electric heating element and a switch control, wherein the electric heating element and the switch control are connected to the power supply circuit in series, wherein the power adjustment module is further configured to: in response to the high electric level of the pulse wave, instantly switch on the power supply circuit via the switch control to adjust a current working voltage of the electric heating element equal to a real-time voltage applied to the electric heating element through the power supply circuit, such that the electric heater is in the high power working state; and in response to the low electric level of the pulse wave, instantly switch off the power supply circuit via the switch control to adjust the current working voltage of the electric heating element to zero, such that the electric heater is in the low power working state.

In one embodiment, the air heater comprises an electric heater which comprises a power supply circuit, an electric heating element and an adjustable resistor, wherein the electric heating element and the adjustable resistor are connected to the power supply circuit in series, wherein the power adjustment module is further configured to: in response to the high electric level of the pulse wave, reduce the resistance value of the adjustable resistor to increase the current working voltage of the electric heating element, such that the electric heater is in the high power working state; and in response to the low electric level of the pulse wave, increase the resistance value of the adjustable resistor to reduce the current working voltage of the electric heating element, such that the electric heater is in the low power working state.

In one embodiment, the air heater comprises an electric heater which comprises a power supply circuit, an electric heating element and an adjustable resistor, wherein the electric heating element and the adjustable resistor are connected to the power supply circuit in parallel, wherein the power adjustment module is further configured to: in response to the high electric level of the pulse wave, increase the resistance value of the adjustable resistor to increase the current working voltage of the electric heating element, such that the electric heater is in the high power working state; and in response to the low electric level of the pulse wave, reduce the resistance value of the adjustable resistor to reduce the current working voltage of the electric heating element, such that the electric heater is in the low power working state.

In one embodiment, the air heater comprises a fluid heat exchanger which comprises a heat supply pipeline, a fluid heat exchange element and a flow control device, wherein the fluid heat exchange element and the flow control device are connected to the heat supply pipeline, wherein the power adjustment module is further configured to: in response to the high electric level of the pulse wave, increase the flow rate of the thermal fluid delivered to the fluid heat exchange element via the heat supply pipe through the flow control device, such that the fluid heat exchanger is in the high power working state; and in response to the low electric level of the pulse wave, reduce the flow rate of the thermal fluid delivered to the fluid heat exchange element via the heat supply pipe through the flow control device, such that the fluid heat exchanger is in the low power working state.

In accordance with another aspect of the invention, the present invention comprises an electronic device for an air fryer, comprising:

a processor for executing program instructions; and

a memory that stores the program instructions being executed by the processor to implement a control method, wherein the control method comprises the following steps.

S100: Detect and analyze an air temperature in the air frying chamber of the air fryer in a real-time manner to obtain a temperature change in the air frying chamber.

S200: Modulate a parameter of a stepless control signal according to a preset target temperature and the temperature change.

S300: In response to the modulated stepless control signal, adjust a heating power of the air heater of the air fryer in a stepless manner, so as to maintain the air temperature in the air frying chamber between an upper limit and a lower limit of the preset target temperature.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a flow chart illustrating a stepless temperature control method according to a preferred embodiment of the present invention.

FIG. 2 is a graph illustrating a stepless control signal in the stepless temperature control method as an example according to the above preferred embodiment of the present invention.

FIG. 3 is a graph illustrating a temperature fluctuation curve in the stepless temperature control method according to the above preferred embodiment of the present invention.

FIG. 4 is a flow chart illustrating a power adjustment step in the stepless temperature control method according to the above preferred embodiment of the present invention.

FIG. 5 is a flow chart illustrating a step of signal modulation in the stepless temperature control method according to the above preferred embodiment of the present invention.

FIG. 6 is a schematic view illustrating a first example of the stepless temperature control method according to the above preferred embodiment of the present invention.

FIG. 7 is a graph illustrating a duty ratio change in the stepless temperature control method according to the above preferred first example of the present invention.

FIG. 8 is a schematic view illustrating a second example of the stepless temperature control method according to the above preferred embodiment of the present invention.

FIG. 9 is a schematic view illustrating a third example of the stepless temperature control method according to the above preferred embodiment of the present invention.

FIG. 10 illustrates a first alternative mode of the stepless temperature control method according to the above preferred embodiment of the present invention.

FIG. 11 is a graph illustrating the phase change in the stepless temperature control method in the first alternative mode according to the above preferred embodiment of the present invention.

FIG. 12 illustrates a second alternative mode of the stepless temperature control method according to the above preferred embodiment of the present invention.

FIG. 13 is a schematic view illustrating a first example of the stepless temperature control method in the second alternative mode according to the above preferred embodiment of the present invention.

FIG. 14 is a schematic view illustrating a second example of the stepless temperature control method in the second alternative mode according to the above preferred embodiment of the present invention.

FIG. 15 is a schematic view illustrating a third example of the stepless temperature control method in the second alternative mode according to the above preferred embodiment of the present invention.

FIG. 16 is a schematic view illustrating a stepless temperature control system according to the above preferred embodiment of the present invention.

FIG. 17 is a schematic view illustrating an electronic device according to the above preferred embodiment of the present invention.

FIG. 18 is a schematic view illustrating an air fryer according to the above preferred embodiment of the present invention.

FIG. 19 is a perspective view of the air fryer according to the above preferred embodiment of the present invention.

FIG. 20 is a sectional view of the air fryer according to the above preferred embodiment of the present invention.

FIG. 21 is an exploded perspective view of the air fryer according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

It is appreciated that the terms “longitudinal”, “transverse”, “upper”, “lower”, “front”, “rear”, “left”, “right”, vertical”, “horizontal”, “top”, “bottom”, “interior” and “exterior” in the following description refer to the orientation or positioning relationship in the accompanying drawings for easy understanding of the present invention without limiting the actual location or orientation of the present invention. Therefore, the above terms should not be an actual location limitation of the elements of the present invention.

It is appreciated that the terms “one” in the following description refer to “at least one” or “one or more” in the embodiment. In particular, the term “a” in one embodiment may refer to “one” while in another embodiment may refer to “more than one”. Therefore, the above terms should not be an actual numerical limitation of the elements of the present invention.

Accordingly, an air fryer incorporates a switch such as mechanical relays to control the electric heater through an open circuit and a closed circuit, such that the electric heater is only operated in two working modes, i.e. a zero power working mode and a full power working mode. Under the full power working mode, the electric heater is operated to generate maximum heat to rapidly increase the air temperature in the existing air fryer. Under the zero power working mode, the electric heater is stopped operating, such that no heat will be generated. As a result, the air temperature in the existing air fryer will be rapidly dropped. Therefore, the air temperature in the existing air fryer will have a large fluctuation range because the electric heater is kept switching on and off between the zero power working mode and the full power working mode. The vast air temperature fluctuation in the existing air fryer will affect the air-frying process to cook the food, such as the appearance and the taste of the food.

In order to reduce the fluctuation range of the air temperature in the existing air fryer, a conventional temperature control solution is to provide multiple electric heaters with different heating powers in the conventional air fryer. One or more of the electric heaters are selectively operated at the full power mode according to the preset air temperature so as to reduce the range of the overall heating power. As a result, the temperature fluctuation range in the existing air fryer is reduced to prevent on the air frying effect of the existing air fryer due to the vast air temperature fluctuation. However, such conventional temperature control will not only greatly increase the complicated structure and manufacturing difficulty of the air fryer, but also provide limited space for limited number of electric heaters to be installed. Therefore, the overall heating power in the existing air fryer is still configured to be switched in an on-and-off manner, such that it cannot reduce the temperature fluctuation range in the existing air fryer, and it cannot meet the high standard of excellent air frying effect to provide a constant air temperature.

In fact, in order to obtain an excellent air frying effect, the air flowing in the air fryer needs to be kept as constant as possible. In other words, the smaller the temperature fluctuation range of the air flowing in the air fryer, the better the air frying effect. In order to achieve this objective, the present invention provides a stepless temperature control method and its system and equipment to adjust an overall heating power of the air fryer in a stepless manner according to the temperature change of the air flowing in the air fryer, so as to minimize the temperature fluctuation range of the air flowing in the air fryer. Therefore, the stepless temperature control method can enhance the air frying effect of the air fryer for air-frying the food. It is appreciated that the food to be air-fried in the present invention can be, but not limited to, foods such as French fries, vegetables, meats, fishes, or etc. It is appreciated that inedible industrial products can be placed in the air fryer of the present invention, and it should not be limited in the present invention.

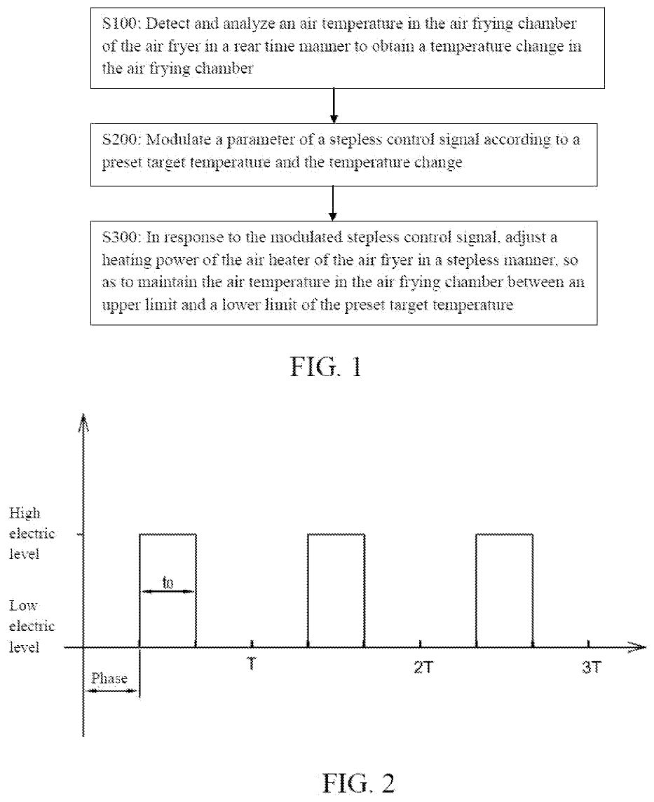

Referring to FIGS. 1 to 7 of the drawings, a stepless temperature control method according to a preferred embodiment of the present invention is illustrated, wherein the stepless temperature control method is configured for controlling an air fryer 1. Accordingly, the air fryer 1 has an air frying chamber 10 for the food placing therein and comprises an air circulation device 20 for driving an air flow into the air frying chamber 10, and an air heater 30 for heating up the air to flow in the air frying chamber 101. Therefore, after the food is placed in the air frying chamber 10, the air heated by the air heater 30 and blown by the air circulation device 20 will contact with the food so as to complete the air frying process for air-frying the food in the air frying chamber 10.

It is appreciated that the air fryer 1 is illustrated as an example in FIGS. 1 to 7 to show the distinctive features of the stepless temperature control method of the present invention. However, the specific structure of the air fryer 1 is only disclosed as an example, and it should form any limitation of the stepless temperature control method of the present invention. For example, in other examples of the present invention, the air fryer 1 can also be implemented with other specific structures to achieve the same desired air frying effect.

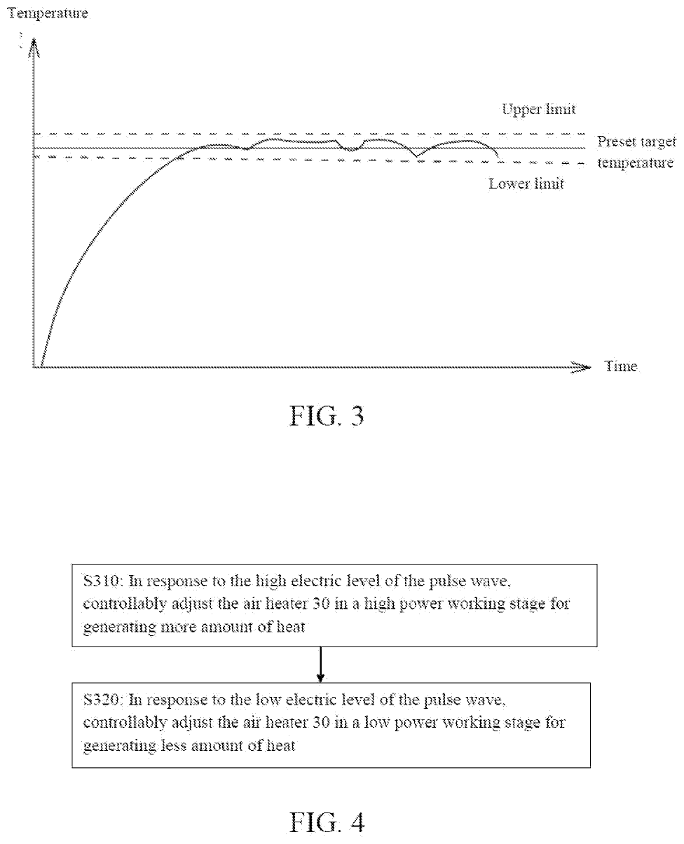

Accordingly, as shown in FIGS. 1 and 3, the stepless temperature control method according to the preferred embodiment comprises the following steps.

S100: Detect and analyze an air temperature in the air frying chamber 10 of the air fryer 1 in a real-time manner to obtain a temperature change in the air frying chamber.

S200: Modulate a parameter of a stepless control signal according to a preset target temperature and the temperature change.

S300: In response to the modulated stepless control signal, adjust a heating power of the air heater 30 of the air fryer 1 in a stepless manner, so as to maintain the air temperature in the air frying chamber between an upper limit and a lower limit of the preset target temperature.

It is worth mentioning that, in response to the stepless control signal, the stepless temperature control method of the present invention is able to adjust the heating power of the air heater 30 in a stepless manner, such that the air heater 30 is adapted to operate at any heating power between zero power and full power. In other words, the stepless temperature control method of the present invention is able continuously adjust the heating power of the air heater 30. Unlike the existing temperature control method, the heating power is controlled at either zero power or full power. Therefore, the stepless temperature control method of the present invention can minimize the air temperature fluctuation range in the air frying chamber 10 of the air fryer 1.

Preferably, the stepless control signal of the present invention is implemented as a pulse wave, wherein the parameter of the stepless control signal includes, but is not limited to, the duty ratio of the pulse wave. It is appreciated that the pulse wave can be implemented as, but not limited to, a rectangular wave, a saw-tooth wave, a triangular wave, a spike wave, a step wave, etc. For easy understanding, the rectangular wave is taken as an example for illustration in the present invention. Furthermore, the duty ratio of the pulse wave refers to the ratio between the pulse width (i.e. the time to corresponding to the high electrical level of the pulse wave within a pulse period T) and the pulse period T, i.e. t₀/T.

Preferably, the pulse frequency of the stepless control signal of the present invention can be set above 50 Hz. In other words, a state switching frequency of the air heater 30 is also set above 50 Hz (i.e. the air heater 30 will switch its state at least once within 20 ms), to improve an accuracy of adjusting the heating power of the air heater 30. It is appreciated that, in other examples of the present invention, the pulse frequency of the stepless control signal can be set less than 50 Hz, which should not be limited in the present invention.

It is worth mentioning that, as shown in FIG. 4, the step S300 of the stepless temperature control method according to the preferred embodiment further comprises the following steps.

S310: In response to the high electric level of the pulse wave, controllably adjust the air heater 30 in a high power working state for generating more amount of heat.

S320: In response to the low electric level of the pulse wave, controllably adjust the air heater 30 in a low power working state for generating less amount of heat.

It is worth mentioning that when the duty ratio of the pulse wave is increased, the pulse time of the pulse wave becomes larger, such that the operation time of the air heater 30 in the high power working state within one pulse period will be prolonged while the operation time of the air heater 30 in the low power working state will be shortened, so as to increase the heating power of the air heater 30. Correspondingly, when the duty ratio of the pulse wave is reduced, the pulse time of the pulse wave becomes smaller, such that the operation time of the air heater 30 in the high power working state within one pulse period will be shortened while the operation time of the air heater 30 in the low power working state will be prolonged, so as to decrease the heating power of the air heater 30.

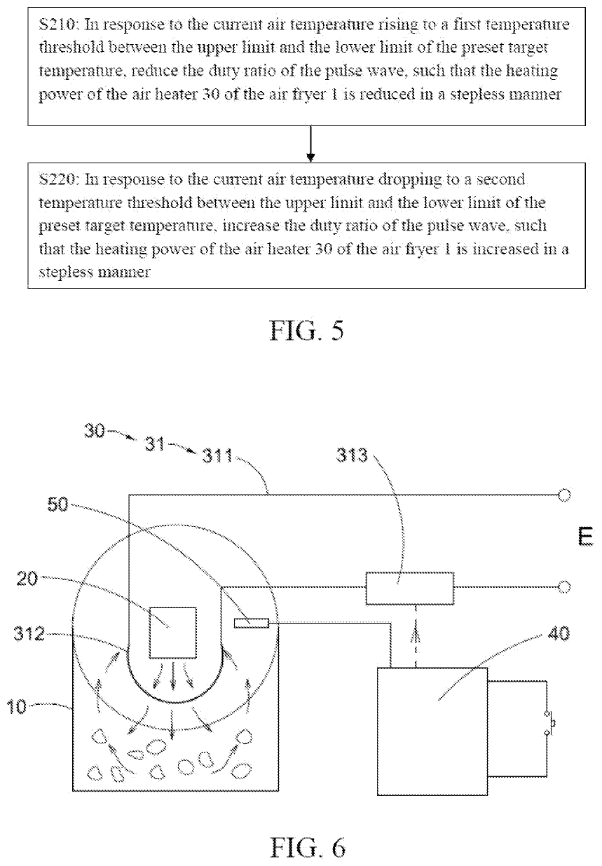

As shown in FIG. 5, the step S200 of the stepless temperature control method according to the preferred embodiment further comprises the following steps.

S210: In response to the current air temperature rising to a first temperature threshold between the upper limit and the lower limit of the preset target temperature, reduce the duty ratio of the pulse wave, such that the heating power of the air heater 30 of the air fryer 1 is reduced in a stepless manner.

S220: In response to the current air temperature dropping to a second temperature threshold between the upper limit and the lower limit of the preset target temperature, increase the duty ratio of the pulse wave, such that the heating power of the air heater 30 of the air fryer 1 is increased in a stepless manner.

It is worth mentioning that since the duty ratio of the pulse wave can be precisely fine-adjusted, the time that the air heater 30 is in a high power working state within a pulse period can change slightly. Therefore, the stepless temperature control method of the present invention is able to adjust the heating power of the air heater 30 in a stepless manner so as to minimize the temperature fluctuation range of the air flowing in the air frying chamber 10 of the air fryer 1. In other words, when the current air temperature increases to the first temperature threshold, the heating power of the air heater 30 can be adjustably reduced by reducing the duty ratio of the pulse wave, such that the air temperature in the air frying chamber 10 of the air fryer 1 will also decrease accordingly. Likewise, when the current air temperature drops to a second temperature threshold, the heating power of the air heater 30 can be adjustably increased by increasing the duty ratio of the pulse wave, such that the air temperature in the air frying chamber 10 of the air fryer 1 will also increase accordingly.

Preferably, both the first temperature threshold and the second temperature threshold can be configured as the preset target temperature to further reduce the upper limit and the lower limit of the preset target temperature. It is appreciated that in other examples of the present invention, the first temperature threshold can be set at any temperature between the preset target temperature and the upper limit of the preset target temperature while the second temperature threshold can be set at any temperature between the lower limit of the preset target temperature and the preset target temperature.

Particularly, when the air fryer 1 is initially started, the air temperature in the air frying chamber 10 of the air fryer 1 is usually low (i.e. much lower than the preset target temperature). Meanwhile, the air fryer 1 is required to rapidly increase the air temperature in the air frying chamber 10 to the preset target temperature so as to increase the air frying efficiency. Therefore, the air heater 30 of the air fryer 1 usually operated at the full power mode. Once the air frying process of the air fryer 1 is completed, the air temperature in the air frying chamber 10 of the air fryer 1 is usually relatively high (i.e. much higher than the preset target temperature). Meanwhile, the air fryer 1 is required to rapidly decrease the air temperature in the air frying chamber 10 to prevent the food from being burnt. Otherwise, the food must be taken out of the air frying chamber 10 as soon as possible. Therefore, the air heater 30 of the air fryer 1 usually operated at the zero power mode.

According to the preferred embodiment, as shown in FIG. 6, the air heater 30 of the air fryer 1 can be, but is not limited to, implemented as an electric heater 31 disposed in the air fryer chamber 10, wherein the electric heater 31 is configured to convert electric energy into heat energy for heating up the air in the air frying chamber 10.

As a first example as shown in FIG. 6, the electric heater 31 comprises a power supply circuit 311 for operatively connecting to a power source E, an electric heating element 312 operatively connected to the power supply circuit 311, and a switch control 313 operatively connected to the power supply circuit 311, wherein the switch control 313 and the electric heating element 312 are electrically connected to the power supply circuit 311 in series. The switch control 313 is configured to instantly switch on and off the power supply circuit 311 in response to the stepless control signal, so as to adjust a heating value of the electric heating element 312 in a real time manner. In other words, the switch control 313 is configured to adjust an amount of heat being generated by the electric heating element 312.

It is worth mentioning that the electric heating element 312 of the electric heater 31 is implemented as an electric heating tube or an electric heating wire, etc., wherein the heating power of the electric heater 31 is positively correlated with the effective working voltage or effective working current of the electric heating element 312 of the electric heater 31. In other words, the greater the effective working voltage or effective working current of the electric heating element 312, the greater the heating power of the electric heater 31, and vice versa. It is appreciated that the effective working voltage or the effective working current of the electric heating element 312 can be configured as an average working voltage or an average working current of the electric heating element 312 in one pulse period.

In the first example, in the step S310 of the stepless temperature control method of the preferred embodiment:

In response to the high electric level of the pulse wave, the power supply circuit 311 of the electric heater 31 is instantly switched on via the switch control 313 of the electric heater 31, wherein the current working voltage of the electric heating element 312 of the electric heater 31 is equal to the real time voltage applied to the electric heating element 312 through the power supply circuit 311, such that the electric heater 31 is in the high power working state.

In the first example, in the step S320 of the stepless temperature control method of the preferred embodiment:

In response to the low electric level of the pulse wave, the power supply circuit 311 of the electric heater 31 is instantly switched off via the switch control 313 of the electric heater 31, wherein the current working voltage of the electric heating element 312 of the electric heater 31 is set at zero, such that the electric heater 31 is in the low power working state.

Preferably, the switch control 313 of the electric heater 31 of the present invention is embodied as a solid state relay 3131 to directly drive a large current load through the micro stepless control signal (such as the electric heating element 312). It is appreciated that even though the traditional mechanical relays can also control the output circuit in an on and off manner, there will a huge transient current at the moment when the output circuit is powered on or off, such that the traditional mechanical relay will produce electric sparks at the moment of powering on or off, which will damage the service life of the relay, and there is a huge safety hazard. Furthermore, the traditional mechanical relay requires long operating time, such that it cannot meet the requirements of the stepless temperature control method of the present invention for high frequency switching or instant switching.

It is worth mentioning that in daily life, the power source used by the air fryer 1 is an alternating current. For example, AC power with a frequency of 50 HZ is usually used in China, and AC power with a frequency of 60 HZ is usually used in the United States. When the power supply circuit 311 of the electric heater 31 is instantly switched on by the switch control 313 of the electric heater 31, the current working voltage of the electric heating element 312 of the electric heater 31 will also adjust over the time, such that the effective working voltage of the electric heater 31 will adjust according to the change of the duty ratio of the wireless control signal.

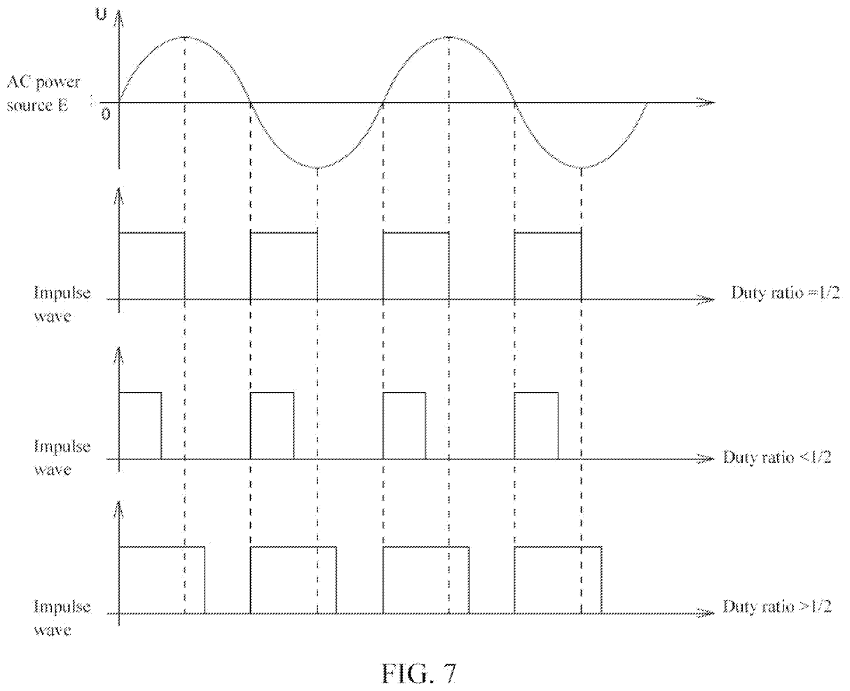

In one example, as shown in FIG. 7, assumed that the power supply E providing 50 Hz alternating current, and the stepless control signal being a pulse wave with a frequency of 100 Hz, when the duty ratio of the stepless control signal is adjusted at ½, the effective working voltage of the electric heater 31 is equal to half of the effective voltage of the power source E. When the duty ratio of the stepless control signal is adjusted to be less than ½, the effective operating voltage of the electric heater 31 becomes smaller and is set less than half of the effective voltage of the power supply E, such that the heating power of the electric heater 31 can be reduced. When the duty ratio of the stepless control signal is adjusted to be greater than ½, the effective operating voltage of the electric heater 31 becomes greater and is set greater than half of the effective voltage of the power supply E, such that the heating power of the electric heater 31 can be increased.

It is worth mentioning that in the second example of the present invention as shown in FIG. 8, the switch control 313 of the electric heater 31 can also be replaced by an adjustable resistor 314, wherein the adjustable resistor 314 and the electric heating element 312 are electrically connected to the power supply circuit 311 in series to adjust the effective working voltage of the electric heating element 312 by adjusting a resistance value of the adjustable resistor 314, so as to accurately regulate the heating power of the electric heater 31. It is appreciated that in the second example of the present invention, the power supply E is preferably embodied as a constant voltage power supply to ensure the voltage of the electric heating element 312 being accurately adjusted via the adjustment of the resistance value of the adjustable resistor 314.

In the second example, in the step S310 of the stepless temperature control method of the preferred embodiment:

In response to the high electric level of the pulse wave, the resistance value of the adjustable resistor 314 is reduced to increase the current working voltage of the electric heating element 312 of the electric heater 31, such that the electric heater 31 is in the high power working state.

In the second example, in the step S320 of the stepless temperature control method of the preferred embodiment:

In response to the low electric level of the pulse wave, the resistance value of the adjustable resistor 314 is increased to reduce the current working voltage of the electric heating element 312 of the electric heater 31, such that the electric heater 31 is in the low power working state.

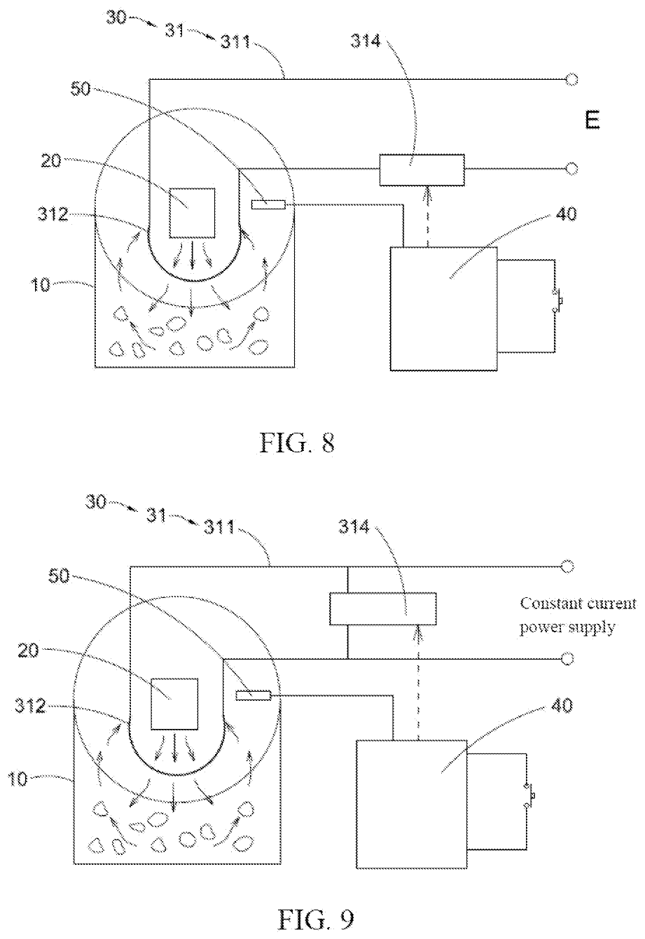

In the third example of the present invention as shown in FIG. 9, the power supply E is embodied as a constant current power supply, wherein the adjustable resistor 314 and the electric heating element 312 are electrically connected to the power supply circuit 311 in parallel. The effective working current of the electric heating element 312 can be adjusted by adjusting the resistance value of the adjustable resistor 314, so as to accurately regulate the heating power of the electric heater 31.

In the third example, in the step S310 of the stepless temperature control method of the preferred embodiment:

In response to the high electric level of the pulse wave, the resistance value of the adjustable resistor 314 is increase to increase the current working voltage of the electric heating element 312 of the electric heater 31, such that the electric heater 31 is in the high power working state.

In the third example, in the step S320 of the stepless temperature control method of the preferred embodiment:

In response to the low electric level of the pulse wave, the resistance value of the adjustable resistor 314 is decreased to reduce the current working voltage of the electric heating element 312 of the electric heater 31, such that the electric heater 31 is in the low power working state.

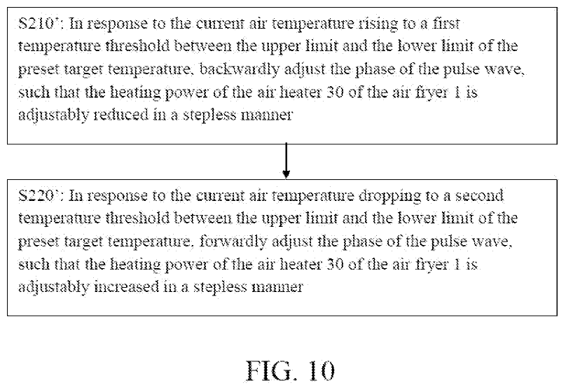

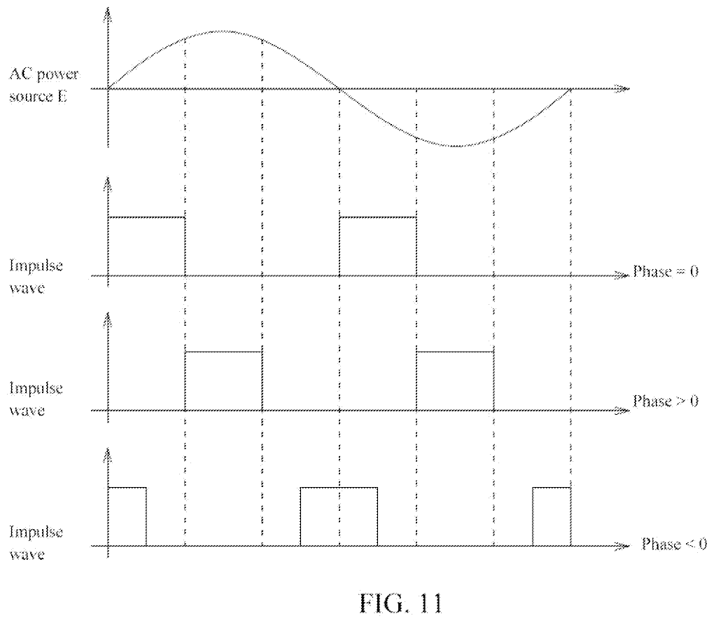

It is worth mentioning that FIGS. 10 and 11 illustrate a first alternative mode of the stepless temperature control method according to the above preferred embodiment of the present invention, wherein the parameter of the stepless control signal includes, but is not limited to, the phase of the pulse wave. It is appreciated that the phase of the pulse wave refers to the ratio of the start time difference of the high electric level of the pulse wave to the pulse period.

Particularly, as shown in FIG. 10, the step S200 of the stepless temperature control method according to the preferred embodiment further comprises the following steps.

S210′: In response to the current air temperature rising to a first temperature threshold between the upper limit and the lower limit of the preset target temperature, backwardly adjust the phase of the pulse wave, such that the heating power of the air heater 30 of the air fryer 1 is adjustably reduced in a stepless manner.

S220′: In response to the current air temperature dropping to a second temperature threshold between the upper limit and the lower limit of the preset target temperature, forwardly adjust the phase of the pulse wave, such that the heating power of the air heater 30 of the air fryer 1 is adjustably increased in a stepless manner.

It is worth mentioning that since the phase of the pulse wave can be precisely fine-adjusted, the real-time working voltage of the air heater 30 in the high power working state can be slightly changed, so as to adjust the effective working voltage of the air heating device 30 in one pulse period. Therefore, the stepless temperature control method of the present invention is able to adjust the heating power of the air heater 30 in a stepless manner by adjusting the phase of the pulse wave, so as to minimize the temperature fluctuation range of the air flowing in the air frying chamber 10 of the air fryer 1.

In one example, as shown in FIG. 11, assumed that the power supply E provides 50 HZ alternating current, and the stepless control signal is a pulse wave with a frequency of 100 HZ and a duty ratio of ½. When the phase of the stepless control signal is 0°, the effective working voltage of the electric heater 31 is equal to half of the effective voltage of the power source E. When the phase of the stepless control signal is backwardly adjusted to be less than 0°, the effective working voltage of the electric heater 31 becomes smaller and is set to be less than half of the effective voltage of the power source E, such that the heating power of the electric heater 31 can be reduced. When the phase of the stepless control signal is forwardly adjusted to be greater than 0°, the effective working voltage of the electric heater 31 becomes greater and is set to be greater than half of the effective voltage of the power source E, such that the heating power of the electric heater 31 can be increased. Preferably, the phase of the stepless control signal is adjusted between −45° and 45° to ensure the effective working voltage of the electric heater 31 being positively correlated with the phase of the stepless control signal.

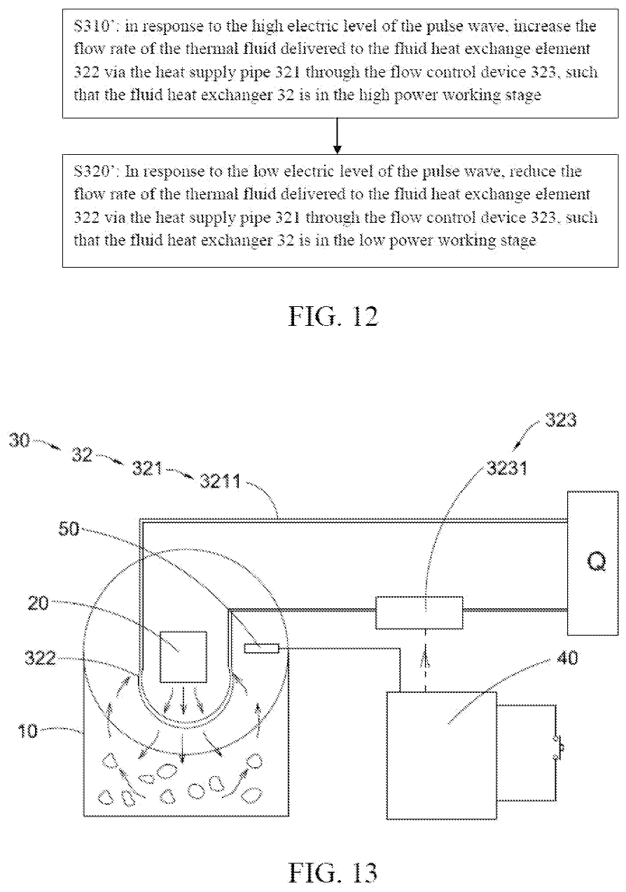

It is worth mentioning that FIGS. 12 and 13 illustrate a second alternative mode of the stepless temperature control method according to the preferred embodiment of the present invention, wherein the air heater 30 can be configured, but not limited to, as a fluid heat exchanger 32 disposed in the air frying chamber 10. Accordingly, the fluid heat exchanger 32 is configured to transfer the thermal energy of the hot fluid to the air in the air frying chamber 10 for heating up the air in the air frying chamber 10.

Particularly, the fluid heat exchanger 32 comprises a heat supply pipeline 321 for communicatively connecting to a heat source Q, a fluid heat exchange element 322 disposed in the heat supply pipeline 321, and a flow control device 323 coupled at the heat supply pipeline 321. Accordingly, the heat source Q is configured to provide thermal fluid, and the flow control device 323 is used to respond to the stepless control signal, wherein the flow rate of the hot fluid delivered to the fluid heat exchange element 322 via the heat supply pipeline 321 is adjusted to adjust the heating power of the fluid heat exchanger 32 in a stepless manner.

It is worth mentioning that the fluid heat exchange element 322 of the fluid heat exchanger 32 is embodied as a coil or the like, wherein the heating power of the fluid heat exchanger 32 is usually set to be positively correlated with the fluid flow rate in the fluid heat exchange element 322 (i.e. the flow rate of the thermal fluid moving along the heating pipe 321). In other words, the greater the flow rate of the thermal fluid moving along the heat supply pipeline 321, the greater the heating power of the fluid heat exchanger 32, and vice versa. It is appreciated that the thermal fluid provided by the heat source Q of the present invention can be embodied as, but not limited to, high temperature gas or high temperature liquid.

Particularly, as shown in FIG. 12, the step S300 of the stepless temperature control method according to the second alternative of the present invention further comprises the following steps.

S310′: In response to the high electric level of the stepless control signal, increase the flow rate of the thermal fluid delivered to the fluid heat exchange element 322 via the heating pipe 321 through the flow control device 323, such that the fluid heat exchanger 32 is in the high power working state.

In response to the low electric level of the stepless control signal, reduce the flow rate of the thermal fluid delivered to the fluid heat exchange element 322 via the heating pipe 321 through the flow control device 323, such that the fluid heat exchanger 32 is in the low power working state.

FIG. 13 illustrates a first example of the stepless temperature control method according to the second alternative mode of the present invention, wherein the flow control device 323 comprises an on-off valve 3231. The on-off valve 3231 and the fluid heat exchange element 322 are connected to the heating pipe 321 in series for responding to the stepless control signal in order to instantly open and close the heat supply pipeline 321 to switch the real-time flow rate of the thermal fluid delivered to the fluid heat exchange element 322 via the heat supply pipeline 321.

Preferably, in the first example of the stepless temperature control method according to the second alternative of the present invention:

In response to the high electric level of the pulse wave, the heat supply pipeline 321 of the fluid heat exchanger 32 is instantly opened via the on-off valve 3231, wherein the current flow rate of the thermal fluid flowing through the fluid heat exchange element 322 is equal to the real-time flow rate of the thermal fluid moving along the heating pipe 321, such that the fluid heat exchanger 32 is in the high power working state.

In response to the low electric level of the pulse wave, the heat supply pipeline 321 of the fluid heat exchanger 32 is instantly closed via the on-off valve 3231, wherein the current flow rate of the thermal fluid flowing through the fluid heat exchange element 322 is zero, such that the fluid heat exchanger 32 is in the low power working state.

It is worth mentioning that since the hot fluid provided by the heat source Q usually flows in the heat supply pipe 321 under the action of a pump, the total flow rate of the hot fluid flowing in the heating pipe 321 will be constant. Therefore, in order to change the flow rate of the hot fluid flowing through the fluid heat exchange element 322, the heat supply pipeline 321 of the fluid heat exchanger 32 comprises a main pipeline 3211 and a bypass pipeline 3212 for the fluid heat exchange element 322. The on-off valve 3231 and the fluid heat exchange element 322 are connected in series with the main pipeline 3211 of the heat supply pipeline 321 for responding to the stepless control signal, to immediately open and close the main pipeline 3211 of the heat supply pipeline 321 so as to adjust the flow rate of the thermal fluid flowing through the fluid heat exchange element 322 (i.e. the flow rate of the thermal fluid via the main pipeline 3211).

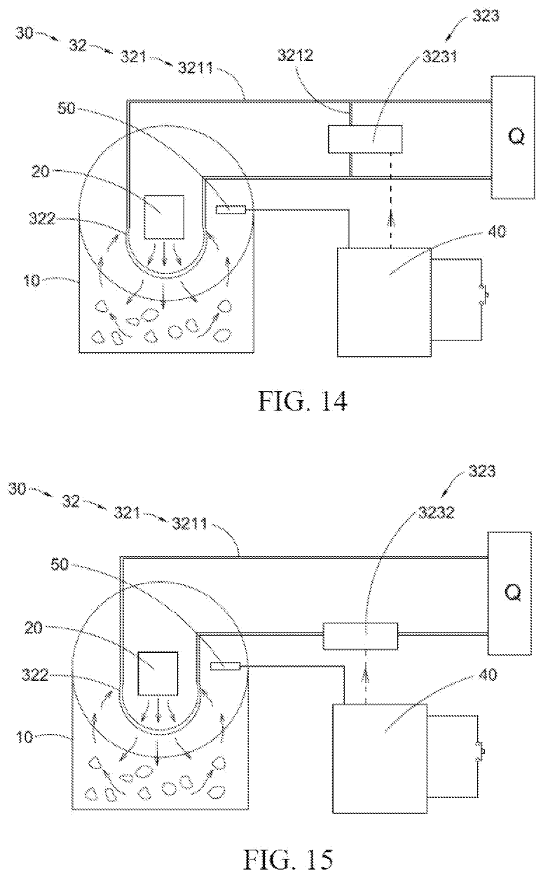

Particularly, FIG. 14 illustrates a second example of the stepless temperature control method according to the second alternative mode of the present invention, wherein the on-off valve 3231 is coupled at the bypass pipeline 3212 of the heat supply pipeline 321 to immediately open and close the bypass pipeline 3212 of the heat supply pipe 321 in response to the stepless control signal so as to adjust the real time flow rate of the thermal fluid flowing through the fluid heat exchange element 322 (i.e. the flow rate of the thermal fluid via the main pipeline 3211).

Preferably, in the second example of the stepless temperature control method according to the second alternative mode of the present invention:

In response to the high electric level of the pulse wave, the bypass pipe 3212 of the heat supply pipe 321 of the fluid heat exchanger 32 is instantly closed via the on-off valve 3231 to increase the real-time flow rate of the hot fluid flowing through the fluid heat exchange element 322, such that the fluid heat exchanger 32 is in the high power working state.

In response to the low electric level of the pulse wave, the bypass pipe 3212 of the heat supply pipe 321 of the fluid heat exchanger 32 is instantly opened via the on-off valve 3231 to reduce the real-time flow rate of the hot fluid flowing through the fluid heat exchange element 322, such that the fluid heat exchanger 32 is in the low power working state.

It is worth mentioning that in other examples of the present invention, the flow control device 323 in the fluid heat exchanger 32 can be embodied as different types of valve such as a variable valve or the like in order to adjust the real-time flow rate of the thermal fluid flowing through the fluid heat exchange element 322 by changing its valve opening, such that the heating power of the fluid heat exchanger 32 can still be adjusted in a stepless manner.

FIG. 15 illustrates a third example of the stepless temperature control method according to the second alternative mode of the present invention, wherein the flow control device 323 comprises a variable valve 3232. The variable valve 3232 and the fluid heat exchange element 322 are connected in series to the heating pipe 321 for responding to the stepless control signal, wherein a valve opening size of variable valve 3232 is changed instantly to adjust the real-time flow rate of the thermal fluid delivered to the fluid heat exchange element 322 via the heat supply pipe 321.

Preferably, in the third example of the stepless temperature control method according to the second alternative mode of the present invention:

In response to the high electric level of the pulse wave, immediately increase the valve opening size of the variable valve 3232 to increase the real-time flow rate of the hot fluid flowing through the fluid heat exchange element 322, such that the fluid heat exchanger 32 is in the high power working state.

In response to the high electric level of the pulse wave, immediately reduce the valve opening size of the variable valve 3232 to reduce the real-time flow rate of the hot fluid flowing through the fluid heat exchange element 322, such that the fluid heat exchanger 32 is in the low power working state.

Referring to FIGS. 6 to 16 of the drawings, a stepless temperature control system according to the above preferred embodiment of the present invention is illustrated, wherein the stepless temperature control system 40 is configured for an air fryer 1. The air fryer 1 has an air frying chamber 10 and comprises an air circulating device 20 for circulating the air in the air frying chamber 10 and an air heater 30 for heating the air circulating in the air frying chamber 10.

Particularly, as shown in FIG. 16, the stepless temperature control system 40 comprises a temperature analysis module 41, a signal modulation module 42, and a power adjustment module 43 operatively connected with each other and controlled by a processor. The temperature analysis module 41 is configured to detect and analyze the air temperature in the air frying chamber 10 in real time to obtain the air temperature change in the frying chamber 10. The signal modulation module 42 is configured to modulate a parameter of a stepless control signal according to the preset target temperature and the air temperature change. The power adjustment module 43 is configured to adjust the heating power of the air heater 30 in a stepless manner in response to the stepless control signal after being modulated, such that the air temperature in the air frying chamber 10 is maintained within the upper limit and the lower limit of the preset target temperature.

It is worth mentioning that the stepless control signal is preferably embodied as a pulse wave, wherein the parameter of the stepless control signal includes the duty ratio and/or phase of the pulse wave.

In one example of the present invention, the power adjustment module 43 is further configured to: in response to the high electric level of the pulse wave, control the air heater 30 in a high power working state to generate more amount of heat; and in response to the low electric level of the pulse wave, control the air heating device 30 in a low power working state to generate less amount of heat.

In one example of the present invention, as shown in FIG. 16, the signal modulation module 42 comprises a duty ratio adjustment module 421 configured to: in response to the current air temperature increasing to a first temperature threshold between the upper limit and the lower limit of the preset target temperature, adjustably reduce the duty ratio of the pulse wave, such that the heating power of the air heater 30 is reduced in a stepless manner, and in response to the current air temperature dropping to a second temperature threshold between the upper limit and the lower limit of the preset target temperature, adjustably increase the duty ratio of the pulse wave, such that the heating power of the air heater 30 is increased in a stepless manner.

In one example of the present invention, as shown in FIG. 16, the signal modulation module 42 further comprises a phase adjustment module 422 configured to: in response to the current air temperature increasing to a first temperature threshold between the upper limit and the lower limit of the preset target temperature, backwardly adjust the phase of the pulse wave, such that the heating power of the air heater 30 is reduced in a stepless manner; and in response to the current air temperature dropping to a first temperature threshold between the upper limit and the lower limit of the preset target temperature, forwardly adjust the phase of the pulse wave, such that the heating power of the air heater 30 is increased in a stepless manner.

In one example of the present invention, as shown in FIG. 16, when the air heater 30 is embodied as the electric heater 31 which is constructed to have the electric heating element 312 and the switch control 313 which are connected to the power supply circuit 311 in series, wherein the power adjustment module 43 is further configured to: in response to the high electric level of the pulse wave, instantly switch on the power supply circuit via the switch control 313 to adjust the current working voltage of the electric heating element 312 equal to the real-time voltage applied to the electric heating element 312 through the power supply circuit 311, such that the electric heater 31 is in the high power working state; and in response to the low electric level of the pulse wave, instantly switch off the power supply circuit 311 via the switch control 313 to adjust the current working voltage of the electric heating element 312 to zero, such that the electric heater 31 is in the low power working state.

In one example of the present invention, as shown in FIG. 8, when the air heater 30 is embodied as the electric heater 31 which is constructed to have the electric heating element 312 and the adjustable resistor 314 which are connected to the power supply circuit 311 in series, wherein the power adjustment module 43 is further configured to: in response to the high electric level of the pulse wave, reduce the resistance value of the adjustable resistor 314 to increase the current working voltage of the electric heating element 312, such that the electric heater 31 is in the high power working state; and in response to the low electric level of the pulse wave, increase the resistance value of the adjustable resistor 314 to reduce the current working voltage of the electric heating element 312, such that the electric heater 31 is in the low power working state.

In one example of the present invention, as shown in FIG. 9, when the air heater 30 is embodied as the electric heater 31 which is constructed to have the electric heating element 312 and the adjustable resistor 314 which are connected to the power supply circuit 311 in parallel, wherein the power adjustment module 43 is further configured to: in response to the high electric level of the pulse wave, increase the resistance value of the adjustable resistor 314 to increase the current working current of the electric heating element 312, such that the electric heater 31 is in the high power working state; and in response to the low electric level of the pulse wave, reduce the resistance value of the adjustable resistor 314 to reduce the current working current of the electric heating element 312, such that the electric heater 31 is in the low power working state.

In one example of the present invention, as shown in FIGS. 13 to 15, when the air heater 30 is embodied as the fluid heat exchanger 32 which is constructed to have the fluid heat exchange element 322 and the flow control device 323 which are connected to the heat supply pipeline 321, wherein the power adjustment module 43 is further configured to: in response to the high electric level of the pulse wave, increase the flow rate of the thermal fluid delivered to the fluid heat exchange element 322 via the heat supply pipe 321 through the flow control device 323, such that the fluid heat exchanger 32 is in the high power working state; and in response to the low electric level of the pulse wave, reduce the flow rate of the thermal fluid delivered to the fluid heat exchange element 322 via the heat supply pipe 321 through the flow control device 323, such that the fluid heat exchanger 32 is in the low power working state.

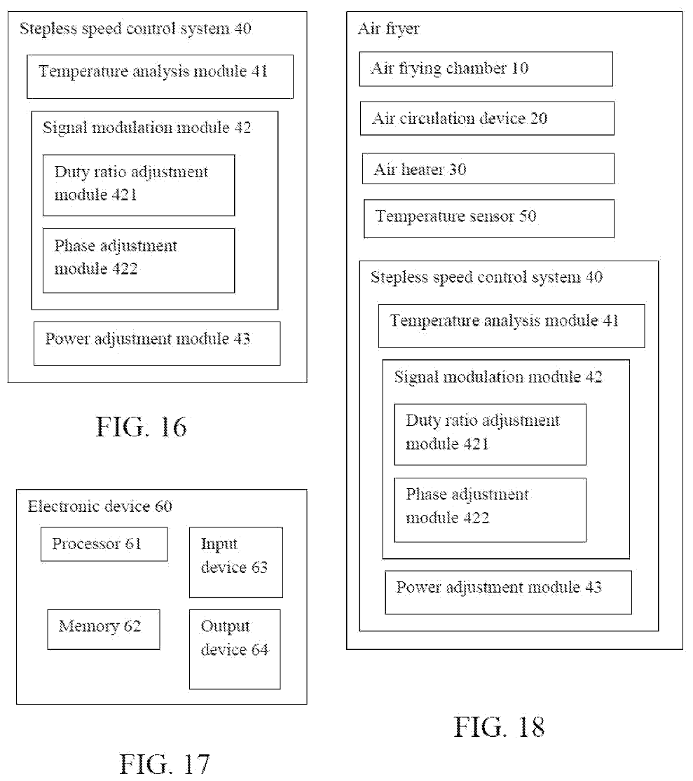

Referring to FIG. 17, an electronic device according to the preferred embodiment of the present invention is illustrated (FIG. 17 is a block diagram of the electronic device according to the preferred embodiment of the present invention). As shown in FIG. 17, the electronic device 60 comprises one or more processors 61 and a memory 62.

The processor 61 is embodied as a central processing unit (CPU) or another form of processing unit with data processing capability and/or instruction execution capability, and can control other components in the electronic device 60 to perform desired functions.

The memory 62 can be one or more computing program unit which is embodied as a computing-readable storage media, such as volatile memory and/or non-volatile memory. For example, the volatile memory can be random access memory (RAM) and/or cache memory (cache), while the non-volatile memory can be read-only memory (ROM), hard disk, flash memory, or the like. Accordingly, one or more computer program instructions can be stored on the computer-readable storage medium, wherein the processor 61 is able to execute the program instructions, so as to process the methods and/or other desired functions of the present invention.

In one example as shown in FIG. 17, the electronic device 60 further comprises: an input device 63 and an output device 64 operatively connected with each other via a bus system and/or other forms of connection mechanisms.

For example, the input device 63 can be, as an example, a camera module for collecting image data or video data.

The output device 64 is able to output different information, including classification results. The output device 64 can be, as an example, a display, a speaker, a printer, a communication network and a remote output device.

Accordingly, the configuration of the electronic device 60 as shown in FIG. 17 is simplified, wherein other components such as buses, input/output interfaces, etc. are omitted. In addition, for the specific applications, the electronic device 60 can also include any other appropriate components.

It is worth mentioning that, as shown in FIGS. 18 to 21, the application of the present invention is shown as the air fryer, wherein the air fryer 1 is incorporated with the stepless speed control system 40. In other words, the stepless speed control system 40 is built-in with the air fryer 1 to minimize the air temperature fluctuation in the air fryer 1.

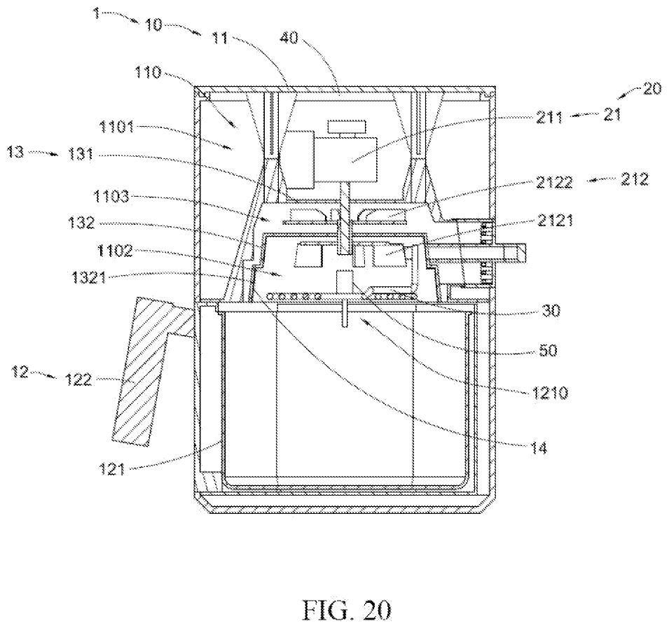

As shown in FIGS. 18 and 20, the air fryer 1 has the air frying chamber 10 for receiving the food therein and comprises the air circulation device 20 for circulating air in the air frying chamber 10, and the air heater 30 for heating the air in the air frying chamber 10. The stepless speed control system 40 is constructed to have the temperature analysis module 41, the signal modulation module 42, and the power adjustment module 43 operatively connected with each other. The temperature analysis module 41 is configured to detect and analyze the air temperature in the air frying chamber 10 in real time to obtain the air temperature change in the air frying chamber 10. The signal modulation module 42 is configured to modulate a parameter of a stepless control signal according to the preset target temperature and the air temperature change. The power adjustment module 43 is configured to adjust the heating power of the air heater 30 in a stepless manner in response to the stepless control signal after being modulated, so as to maintain the air temperature in the air frying chamber 10 between the upper limit and the lower limit of the preset target temperature. Therefore, after placing the food in the air frying chamber 10, the air being circulated by the air circulation device 20 and heated by the air heater 30 will contact to the food in order to complete the air frying process for air-frying the food. Meanwhile, the stepless temperature control system 40 is configured to maintain the air temperature in the air frying chamber 10 between the upper and lower limits of the preset target temperature, so as to improve the air frying ability of the air fryer 1 for the food to be air-fried.

Particularly, the air circulation device 20 of the air fryer 1 comprises a fan 21 disposed in the air frying chamber 10, wherein when the fan 21 is electrically powered on, the fan 21 will blow the air to circulate the air in the air frying chamber 10. In another example, the fan 21 of the air circulation device 20 of the air fryer 1 can be embodied as an external fan externally coupled out of the air frying chamber 10, wherein the fan 21 is communicatively connected to the air frying chamber 10 via an air circulation duct, such that the fan 21 will blow the air to circulate the air in the air frying chamber 10 through the air circulation duct. It is appreciated that the air heater 30 of the air fryer 1 can be, but not limited to, embodied as the electric heater 31 or the fluid heat exchanger 32 to incorporate with the air circulation device 20.

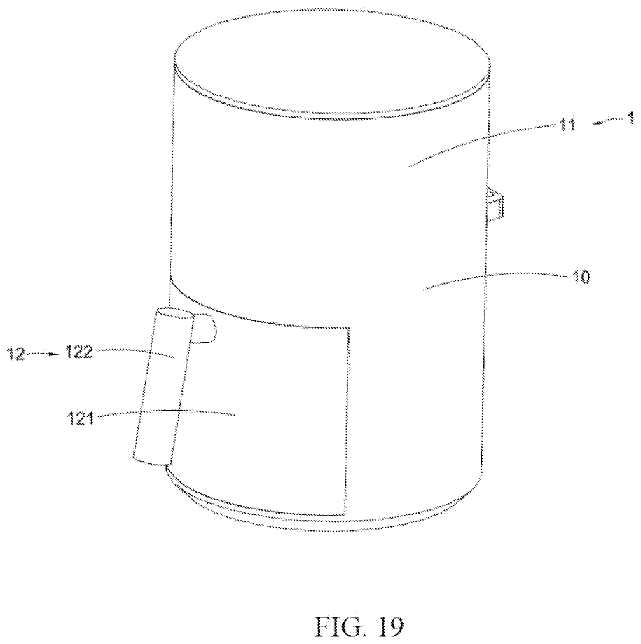

It is worth mentioning that, as shown in FIGS. 19 to 21, the air fryer 1 according to the preferred embodiment of the present invention further comprises a housing 11 defining an interior cavity 110, and an air frying assembly 12 disposed at the housing 11, wherein the air frying assembly 12 is arranged to retain the food in the air frying chamber 10 which is defined in the internal cavity 110, such that when the air is heated by the air heater 30 and is circulated in the internal cavity 110 by the air circulation device 20, the hot air will contact with the food for air-frying the food to complete the air frying process of the air fryer 1.

Preferably, the air frying assembly 12 is detachably coupled to the housing 11 for easily reaching the food in the air frying assembly 12. In one example, the air frying assembly 12 is detachably coupled to the housing 11 by means of, but not limited to, snap fit or lock structure.

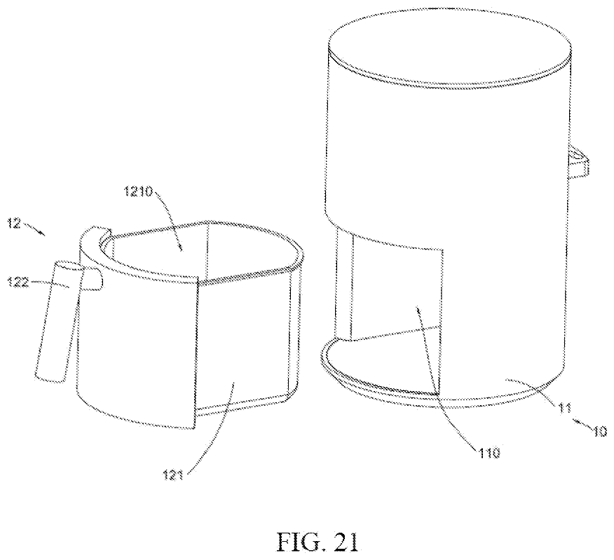

Preferably, as shown in FIGS. 20 and 21, the air frying assembly 12 comprises a basket 121 having at least one basket opening 1210, wherein the basket 121 is arranged for holding the food therein to be placed in the air frying chamber 10 when the basket 121 is coupled to the housing 11. The basket opening 1210 is arranged to communicate with the air frying chamber 10, wherein the hot air heated by the air heater 30 can be circulated in the basket 121 via the air circulation device 20 to contact with the food so as to air-fry the food. It is appreciated that the basket 121 can be a net-shaped basket such as a frying basket with a meshing structure.

Preferably, the air frying assembly 12 further comprises a handle 122 extended from the basket 121, wherein when the basket 121 is placed in the air frying chamber 10, the handle 122 is located out of the internal cavity 110 of the housing 11 for the user to carry the basket 121.

It is appreciated that the air frying assembly 12 can incorporate with different components such as rotating grill, skewers and other cooking components, as long as the food can be air-fried in the interior cavity 110 of the housing 11.

As shown in FIG. 20, the fan 21 of the air circulation device 20 according to the preferred embodiment of the present invention comprises a motor 211 and a fan blade assembly 212 being driven by the motor 211, wherein when the motor 211 is actuated, the fan blade assembly 212 is driven to rotate for blowing the air in the air frying chamber 10 so as to circulate the air therein.

It is worth mentioning that since the temperature of the air is heated by air heater 30, i.e. the hot air, is relatively high, water content of the food will be removed by the hot air so as to form a relative high temperature and humid environment in the air frying chamber 10. As the electric motor 211 of the fan 21 works under such high temperature and humid environment, the service life of the electric motor 211 will be shortened and safety issue is concerned. In order to solve this problem, the air fryer 1 of the present invention further comprises a partition assembly 13 disposed in the housing 11 to divide the interior cavity 110 into an upper compartment 1101 and a lower compartment 1102. The electric motor 211 of the fan 21 is disposed at the upper compartment 1101 of the interior cavity 110. The fan blade assembly 212 of the fan 21 further comprises a first fan blade 2121 disposed in the lower compartment 1102 of the interior cavity 110 for circulating the air in the lower compartment 1102 when the first fan blade 2121 is drive to rotate by the electric motor 211. Meanwhile, the air frying assembly 12 and the air heater 30 are disposed in the lower compartment 1102 of the interior cavity 110 to form the high temperature and humid environment in the lower compartment 1102 of the interior cavity 110. Therefore, the air fryer 1 of the present invention will ensure the air-frying process being completed in the lower compartment 1102 for air-frying the food and will maintain a relatively dry environment in the upper compartment 1101 of the interior cavity 110, so as to prolong the service life span of the electric motor 211 of the fan 21 and to ensure the safety concern of the air fryer 1.

Preferably, the partition assembly 13 comprises an upper partition member 131 and a lower partition member 132 spaced apart from each other, wherein the upper partition member 131 and the lower partition member 132 are disposed in the interior cavity 110 of the housing 11 to form an intermediate compartment 1103 between the upper compartment 1101 and the lower compartment 1102. In other words, the interior cavity 110 of the housing 110 is divided into the upper compartment 1101, the intermediate compartment 1103, and the lower compartment 1102 from top to bottom by the upper partition member 131 and the lower partition member 132. Accordingly, the intermediate compartment 1103 serves as a heat blocking compartment to block the heat from the lower compartment 1102 to the upper compartment 1101, so as to prevent the electric motor 211 of fan 21 being operated in a high temperature environment.

Preferably, the fan blade assembly 212 of the fan 21 further comprises a second fan blade 2122 disposed at the intermediate compartment 1103 of the interior cavity 110, wherein the second fan blade 2122 is driven to rotate by the electric motor 211 to generate an air flow in the intermediate compartment 1103 so as to enhance the heat insulation ability of the intermediate compartment 1103. It is appreciated that the first and second fan blades 2121, 2122 are coupled at the same output shaft of the electric motor 211, wherein the second fan blade 2122 is located between the first fan blade 2121 and the electric motor 211. In other words, the first fan blade 2121 is located out of the intermediate compartment 1103, wherein the first fan blade 2121 serves as an outer fan blade while the second fan blade 2122 serves as an inner fan blade.

It is worth mentioning that since the lower partition member 132 of the partition assembly 13 and the lower portion of the housing 11 together form the lower compartment 1102 of the interior cavity 110, the lower surface 1321 of the lower partition member 132 serves as a ceiling of the lower compartment 1102, such that the lower surface 1321 of the lower partition member 132 will inevitably contact with the hot air circulating in the lower partition member 132. Therefore, the greases and dirt carried in the hot air can be easily adhered to the lower surface 1321 of the lower partition member 132, wherein the greases and dirt are not only difficult to be removed but also easy for bacteria growing, such that hygiene and safety of the air fryer 1 are concerned.

As shown in FIG. 20, in order to solve this problem, the air fryer 1 further comprises a non-stick coating 14 provided on the surface of the partition assembly 13 to ensure the sanitation of the air fryer. It is appreciated that the non-stick coating 14 can be embodied as, but not limited to, a Teflon coating or a ceramic coating.

Preferably, the lower surface 1321 of the lower partition member 132 of the partition assembly 13 is also coated with the non-stick coating 14 to reduce the grease stains adhered to the lower surface 1321 of the lower partition member 132.

Preferably, other wall surfaces of the lower compartment 1102, such as the bottom wall surface and the side wall surfaces thereof, are also coated with the non-stick coating 14 to ensure the sanitation of the air fryer.

It is worth mentioning that in other examples of the present invention, the non-stick coating 14 is also be provided on different locations of the air frying chamber 10.

Any surface location of the interior cavity 110 contacting with the air flow will be coated with the non-stick coating 14. In other words, the non-stick coating 14 will provide at any surface of the air frying chamber 10 contacting with the air circulating in the interior cavity 110.

It is worth mentioning that, as shown in FIGS. 18 and 20, the air fryer 1 according to the preferred embodiment further comprises a temperature sensor 50 disposed in the air frying chamber 10 and operatively connected to the temperature analysis module 41 of the stepless speed control system 40, wherein the temperature sensor 50 is configured to detect the air temperature in the air frying chamber 10 in a real time manner and to transmit the detected temperature data to the temperature analysis module 41 for analysis. It is appreciated that the temperature sensor 50 can be, but not limited to, a NTC temperature sensor.

Preferably, the temperature sensor 50 is disposed in the lower compartment 1102 of the interior chamber 110 of the housing 11, and is located adjacent to the air heater 30, to accurately detect the air temperature in the lower compartment 1102 in a real time manner.

It is worth mentioning that the stepless speed control system 40 of the air fryer of the present invention can be, but not limited to, be implemented as a single-chip microcomputer or a control chip built-in with the air fryer 1 to form an integrated device. In another example the stepless speed control system 40 can be a control terminal as an external device externally connected to the air fryer 1, such that the air fryer 1 serves as a split device. It is appreciated that the control terminal is operatively connected to the air fryer 1, wherein the air fryer 1 can still be controlled in a stepless manner through the control terminal to provide good air frying ability.

Furthermore, in an example of the present invention as shown in FIG. 6, the air heater 30 is embodied as the electric heater 31 constructed to have the electric heating element 312 and the switch control 313 electrically connected to the power supply circuit 311 in series, wherein the electric heating element 312 is disposed in the air frying chamber 10. The switch control 312 is operatively connected to the power adjustment module 43 of the stepless temperature control system 40. The power adjustment module 43 is further configured to control the switch control 312 to immediately switch on or off the power supply circuit 311 in response to the stepless control signal, so as to switch the electric heater 31 between the high power working state and the low power working state.

Furthermore, in another example of the present invention as shown in FIGS. 8 and 9, the air heater 30 is embodied as the electric heater 31 constructed to have the electric heating element 312 and the adjustable resistor 314 electrically connected to the power supply circuit 311 in series or in parallel, wherein the electric heating element 312 is disposed in the air frying chamber 10. The adjustable resistor 314 is operatively connected to the power adjustment module 43 of the stepless temperature control system 40. The power adjustment module 43 is further configured to adjust the resistance value of the adjustable resistor 314 in response to the stepless control signal, so as to switch the electric heater 31 between the high power working state and the low power working state.

Furthermore, in another example of the present invention as shown in FIGS. 19 to 15, the air heater 30 is embodied as the fluid heat exchanger 32 constructed to have the heat supply pipeline 321, the fluid heat exchange element 322 and the flow control device 323, wherein the fluid heat exchange element 322 is disposed in the air frying chamber 10. The flow control device 323 is operatively connected to the power adjustment module 43 of the stepless temperature control system 40. The power adjustment module 43 is further configured to control the flow control device 323 to instantly adjust the flow rate of the thermal fluid supplied to the fluid heat exchange element 322 via the heat supply pipe 321 in response to the stepless control signal, so as to switch the fluid heat exchanger 32 between the high power working state and the low power working state.

It is appreciated that the terms “devices”, “equipments”, “systems”, “module” and “unit” in the description and block diagram of the present invention are merely illustrative examples and are not intended to be connected, arranged, and configured in the manner shown in the block diagrams. A person who skilled in the art should will recognize, these devices, equipments, systems, modules and unit can be connected, arranged, and configured in any manner. The terms “include”, “include”, “have”, etc. are open end and mean “including but not limited to” and can be used interchangeably. The terms “or” and “and” as used herein refer to the terms “and/or” and can be used interchangeably, unless the context clearly indicates otherwise. The term “such as” used herein refers to the phrase “such as but not limited to” and can be used interchangeably.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A stepless temperature control method for an air fryer which comprises an air frying chamber and an air heater, wherein the stepless temperature control method comprises steps of:
(a) detecting and analyzing an air temperature in the air frying chamber of the air fryer in a real-time manner to obtain a temperature change in the air frying chamber;
(b) modulating a parameter of a stepless control signal according to a preset target temperature and the temperature change; and
(c) in response to the modulated stepless control signal, adjusting a heating power of the air heater of the air fryer in a stepless manner, so as to adjust the air temperature in the air frying chamber according to the preset target temperature

2. The stepless temperature control method, as recited in claim 1, the preset target temperature is between an upper limit and a lower limit, wherein the stepless control signal is a pulse wave, wherein the parameter of the stepless control signal includes at least one of a duty ratio and a phase of the pulse wave.

3. The stepless temperature control method, as recited in claim 2, wherein the step (c) further comprises steps of:
in response to a high electric level of the pulse wave, controllably adjusting the air heater in a high power working state for generating more amount of heat; and
in response to a low electric level of the pulse wave, controllably adjusting the air heater in a low power working state for generating less amount of heat.

4. The stepless temperature control method, as recited in claim 3, wherein the step (b) further comprises steps of:
in response to a current air temperature rising to a first temperature threshold between the upper limit and the lower limit of the preset target temperature, reducing the duty ratio of the pulse wave, such that the heating power of the air heater of the air fryer is reduced in a stepless manner; and
in response to the current air temperature dropping to a second temperature threshold between the upper limit and the lower limit of the preset target temperature, increasing the duty ratio of the pulse wave, such that the heating power of the air heater of the air fryer is increased in a stepless manner.

5. The stepless temperature control method, as recited in claim 3, wherein the step (b) further comprises steps of:
in response to a current air temperature rising to a first temperature threshold between the upper limit and the lower limit of the preset target temperature, backwardly adjusting the phase of the pulse wave, such that the heating power of the air heater of the air fryer is adjustably reduced in a stepless manner; and
in response to the current air temperature dropping to a second temperature threshold between the upper limit and the lower limit of the preset target temperature, forwardly adjusting the phase of the pulse wave, such that the heating power of the air heater of the air fryer is adjustably increased in a stepless manner.

6. The stepless temperature control method, as recited in claim 4, wherein the air heater comprises an electric heater which comprises a power supply circuit, an electric heating element and a switch control, wherein the electric heating element and the switch control are connected to the power supply circuit in series, wherein the step (c) further comprises steps of:
in response to the high electric level of the pulse wave, instantly switching on the power supply circuit via the switch control to adjust a current working voltage of the electric heating element equal to a real-time voltage applied to the electric heating element through the power supply circuit, such that the electric heater is in the high power working state; and
in response to the low electric level of the pulse wave, instantly switching off the power supply circuit via the switch control to adjust the current working voltage of the electric heating element to zero, such that the electric heater is in the low power working state.

7. The stepless temperature control method, as recited in claim 5, wherein the air heater comprises an electric heater which comprises a power supply circuit, an electric heating element and a switch control, wherein the electric heating element and the switch control are connected to the power supply circuit in series, wherein the step (c) further comprises steps of:
in response to the high electric level of the pulse wave, instantly switching on the power supply circuit via the switch control to adjust a current working voltage of the electric heating element equal to a real-time voltage applied to the electric heating element through the power supply circuit, such that the electric heater is in the high power working state; and
in response to the low electric level of the pulse wave, instantly switching off the power supply circuit via the switch control to adjust the current working voltage of the electric heating element to zero, such that the electric heater is in the low power working state.

8. The stepless temperature control method, as recited in claim 6, wherein the switch control is a solid state relay.

9. The stepless temperature control method, as recited in claim 7, wherein the switch control is a solid state relay.

10. The stepless temperature control method, as recited in claim 4, wherein the air heater comprises an electric heater which comprises a power supply circuit, an electric heating element and an adjustable resistor, wherein the electric heating element and the adjustable resistor are connected to the power supply circuit in series, wherein the step (c) further comprises the steps of:
in response to the high electric level of the pulse wave, reducing the resistance value of the adjustable resistor to increase the current working voltage of the electric heating element, such that the electric heater is in the high power working state; and
in response to the low electric level of the pulse wave, increasing the resistance value of the adjustable resistor to reduce the current working voltage of the electric heating element, such that the electric heater is in the low power working state.

11. The stepless temperature control method, as recited in claim 5, wherein the air heater comprises an electric heater which comprises a power supply circuit, an electric heating element and an adjustable resistor, wherein the electric heating element and the adjustable resistor are connected to the power supply circuit in series, wherein the step (c) further comprises the steps of:
in response to the high electric level of the pulse wave, reducing the resistance value of the adjustable resistor to increase the current working voltage of the electric heating element, such that the electric heater is in the high power working state; and
in response to the low electric level of the pulse wave, increasing the resistance value of the adjustable resistor to reduce the current working voltage of the electric heating element, such that the electric heater is in the low power working state.

12. The stepless temperature control method, as recited in claim 4, wherein the air heater comprises an electric heater which comprises a power supply circuit, an electric heating element and an adjustable resistor, wherein the electric heating element and the adjustable resistor are connected to the power supply circuit in parallel, wherein the step (c) further comprises the steps of:
in response to the high electric level of the pulse wave, increasing the resistance value of the adjustable resistor to increase the current working voltage of the electric heating element, such that the electric heater is in the high power working state; and
in response to the low electric level of the pulse wave, reducing the resistance value of the adjustable resistor to reduce the current working voltage of the electric heating element, such that the electric heater is in the low power working state.

13. The stepless temperature control method, as recited in claim 5, wherein the air heater comprises an electric heater which comprises a power supply circuit, an electric heating element and an adjustable resistor, wherein the electric heating element and the adjustable resistor are connected to the power supply circuit in parallel, wherein the step (c) further comprises the steps of:
in response to the high electric level of the pulse wave, increasing the resistance value of the adjustable resistor to increase the current working voltage of the electric heating element, such that the electric heater is in the high power working state; and
in response to the low electric level of the pulse wave, reducing the resistance value of the adjustable resistor to reduce the current working voltage of the electric heating element, such that the electric heater is in the low power working state.

14. The stepless temperature control method, as recited in claim 4, wherein the air heater comprises a fluid heat exchanger which comprises a heat supply pipeline, a fluid heat exchange element and a flow control device, wherein the fluid heat exchange element and the flow control device are connected to the heat supply pipeline, wherein the step (c) further comprises the steps of:
in response to the high electric level of the pulse wave, increasing the flow rate of the thermal fluid delivered to the fluid heat exchange element via the heat supply pipe through the flow control device, such that the fluid heat exchanger is in the high power working state; and
in response to the low electric level of the pulse wave, reducing the flow rate of the thermal fluid delivered to the fluid heat exchange element via the heat supply pipe through the flow control device, such that the fluid heat exchanger is in the low power working state.

15. The stepless temperature control method, as recited in claim 5, wherein the air heater comprises a fluid heat exchanger which comprises a heat supply pipeline, a fluid heat exchange element and a flow control device, wherein the fluid heat exchange element and the flow control device are connected to the heat supply pipeline, wherein the step (c) further comprises the steps of:
in response to the high electric level of the pulse wave, increasing the flow rate of the thermal fluid delivered to the fluid heat exchange element via the heat supply pipe through the flow control device, such that the fluid heat exchanger is in the high power working state; and
in response to the low electric level of the pulse wave, reducing the flow rate of the thermal fluid delivered to the fluid heat exchange element via the heat supply pipe through the flow control device, such that the fluid heat exchanger is in the low power working state.

16. An air fryer, comprising:
a housing having an air frying chamber for placing a food therein;
an air circulation device disposed in the housing for circulating air in the air frying chamber;
an air heater disposed in the housing for heating the air in the air frying chamber and
a stepless temperature control system which comprises:
a processor;
a temperature analysis module controlled by the processor and configured to detect and analyze an air temperature in the air frying chamber in real time to obtain an air temperature change of in the air frying chamber;
a signal modulation module controlled by the processor and configured to modulate a parameter of a stepless control signal and
a power adjustment module controlled by the processor and configured to adjust a heating power of the air heater in a stepless manner in response to the modulated stepless control signal.

17. The air fryer, as recited in claim 16, wherein the parameter of a stepless control signal according to the preset target temperature and the air temperature change; the air heater disposed in the housing for heating the air in the air frying chamber at a preset target temperature; the power adjustment module controlled by the processor and configured to adjust a heating power of the air heater in a stepless manner in response to the modulated stepless control signal, so as to maintain the air temperature in the air frying chamber between an upper limit and a lower limit of the preset target temperature. the stepless control signal is a pulse wave, wherein the parameter of the stepless control signal includes at least one of a duty ratio and a phase of the pulse wave.

18. The air fryer, as recited in claim 17, wherein the power adjustment module is further configured to:
in response to a high electric level of the pulse wave, controllably adjust the air heater in a high power working state for generating more amount of heat; and
in response to a low electric level of the pulse wave, controllably adjust the air heater in a low power working state for generating less amount of heat.

19. The air fryer, as recited in claim 18, wherein signal modulation module comprises a duty ratio adjustment module configured to:
in response to a current air temperature rising to a first temperature threshold between the upper limit and the lower limit of the preset target temperature, reduce the duty ratio of the pulse wave, such that the heating power of the air heater of the air fryer is reduced in a stepless manner; and
in response to the current air temperature dropping to a second temperature threshold between the upper limit and the lower limit of the preset target temperature, increase the duty ratio of the pulse wave, such that the heating power of the air heater of the air fryer is increased in a stepless manner.

20. The air fryer, as recited in claim 18, wherein the signal modulation module comprises a phase adjustment module configured to:
in response to a current air temperature rising to a first temperature threshold between the upper limit and the lower limit of the preset target temperature, backwardly adjust the phase of the pulse wave, such that the heating power of the air heater of the air fryer is adjustably reduced in a stepless manner; and
in response to the current air temperature dropping to a second temperature threshold between the upper limit and the lower limit of the preset target temperature, forwardly adjust the phase of the pulse wave, such that the heating power of the air heater of the air fryer is adjustably increased in a stepless manner.

21. The air fryer, as recited in claim 19, wherein the air heater comprises an electric heater which comprises a power supply circuit, an electric heating element and a switch control, wherein the electric heating element and the switch control are connected to the power supply circuit in series, wherein the power adjustment module is further configured to:
in response to the high electric level of the pulse wave, instantly switch on the power supply circuit via the switch control to adjust a current working voltage of the electric heating element equal to a real-time voltage applied to the electric heating element through the power supply circuit, such that the electric heater is in the high power working state; and
in response to the low electric level of the pulse wave, instantly switch off the power supply circuit via the switch control to adjust the current working voltage of the electric heating element to zero, such that the electric heater is in the low power working state.

22. The air fryer, as recited in claim 20, wherein the air heater comprises an electric heater which comprises a power supply circuit, an electric heating element and a switch control, wherein the electric heating element and the switch control are connected to the power supply circuit in series, wherein the power adjustment module is further configured to:
in response to the high electric level of the pulse wave, instantly switch on the power supply circuit via the switch control to adjust a current working voltage of the electric heating element equal to a real-time voltage applied to the electric heating element through the power supply circuit, such that the electric heater is in the high power working state; and
in response to the low electric level of the pulse wave, instantly switch off the power supply circuit via the switch control to adjust the current working voltage of the electric heating element to zero, such that the electric heater is in the low power working state.

23. The air fryer, as recited in claim 21, wherein the switch control is a solid state relay.

24. The air fryer, as recited in claim 22, wherein the switch control is a solid state relay.

25. The air fryer, as recited in claim 19, wherein the air heater comprises an electric heater which comprises a power supply circuit, an electric heating element and an adjustable resistor, wherein the electric heating element and the adjustable resistor are connected to the power supply circuit in series, wherein the power adjustment module is further configured to:
in response to the high electric level of the pulse wave, reduce the resistance value of the adjustable resistor to increase the current working voltage of the electric heating element, such that the electric heater is in the high power working state; and
in response to the low electric level of the pulse wave, increase the resistance value of the adjustable resistor to reduce the current working voltage of the electric heating element, such that the electric heater is in the low power working state.

26. The air fryer, as recited in claim 20, wherein the air heater comprises an electric heater which comprises a power supply circuit, an electric heating element and an adjustable resistor, wherein the electric heating element and the adjustable resistor are connected to the power supply circuit in series, wherein the power adjustment module is further configured to:
in response to the high electric level of the pulse wave, reduce the resistance value of the adjustable resistor to increase the current working voltage of the electric heating element, such that the electric heater is in the high power working state; and
in response to the low electric level of the pulse wave, increase the resistance value of the adjustable resistor to reduce the current working voltage of the electric heating element, such that the electric heater is in the low power working state.

27. The air fryer, as recited in claim 19, wherein the air heater comprises an electric heater which comprises a power supply circuit, an electric heating element and an adjustable resistor, wherein the electric heating element and the adjustable resistor are connected to the power supply circuit in parallel, wherein the power adjustment module is further configured to:
in response to the high electric level of the pulse wave, increase the resistance value of the adjustable resistor to increase the current working voltage of the electric heating element, such that the electric heater is in the high power working state; and
in response to the low electric level of the pulse wave, reduce the resistance value of the adjustable resistor to reduce the current working voltage of the electric heating element, such that the electric heater is in the low power working state.

28. The air fryer, as recited in claim 20, wherein the air heater comprises an electric heater which comprises a power supply circuit, an electric heating element and an adjustable resistor, wherein the electric heating element and the adjustable resistor are connected to the power supply circuit in parallel, wherein the power adjustment module is further configured to:
in response to the high electric level of the pulse wave, increase the resistance value of the adjustable resistor to increase the current working voltage of the electric heating element, such that the electric heater is in the high power working state; and
in response to the low electric level of the pulse wave, reduce the resistance value of the adjustable resistor to reduce the current working voltage of the electric heating element, such that the electric heater is in the low power working state.

29. The air fryer, as recited in claim 19, wherein the air heater comprises a fluid heat exchanger which comprises a heat supply pipeline, a fluid heat exchange element and a flow control device, wherein the fluid heat exchange element and the flow control device are connected to the heat supply pipeline, wherein the power adjustment module is further configured to:
in response to the high electric level of the pulse wave, increase the flow rate of the thermal fluid delivered to the fluid heat exchange element via the heat supply pipe through the flow control device, such that the fluid heat exchanger is in the high power working state; and
in response to the low electric level of the pulse wave, reduce the flow rate of the thermal fluid delivered to the fluid heat exchange element via the heat supply pipe through the flow control device, such that the fluid heat exchanger is in the low power working state.

30. The air fryer, as recited in claim 20, wherein the air heater comprises a fluid heat exchanger which comprises a heat supply pipeline, a fluid heat exchange element and a flow control device, wherein the fluid heat exchange element and the flow control device are connected to the heat supply pipeline, wherein the power adjustment module is further configured to:
in response to the high electric level of the pulse wave, increase the flow rate of the thermal fluid delivered to the fluid heat exchange element via the heat supply pipe through the flow control device, such that the fluid heat exchanger is in the high power working state; and
in response to the low electric level of the pulse wave, reduce the flow rate of the thermal fluid delivered to the fluid heat exchange element via the heat supply pipe through the flow control device, such that the fluid heat exchanger is in the low power working state.
